(19) United States
(12) Patent Application Publication
(10) Pub. No.: US 2021/0198412 A1
(43) Pub. Date: Jul. 1, 2021

(54) ENVIRONMENTALLY FRIENDLY DRIVEN POLYURETHANE SPRAY FOAM SYSTEMS

(71) Applicant: BASF SE, Ludwigshafen am Rhein (DE)

(72) Inventors: Josep-Daniel Eslava, Rubi (ES); Gunnar Kampf, Lemfoerde (DE); Jan-Michael Dreisoerner, Lemfoerde (DE); Josep Maria Bringue Campi, Rubi (ES)

(21) Appl. No.: 17/267,864

(22) PCT Filed: Aug. 8, 2019
(86) PCT No.: PCT/EP2019/071351

§ 371 Date: Feb. 11, 2021

(30) Foreign Application Priority Data
Aug. 16, 2018 (EP) 18382611.4

(51) Int. Cl. C08G 18/42; C08K 5/521; C08J 9/14; C08J 9/00; C08G 18/76; C08G 18/66; C08G 18/65; C08G 18/48; C08G 18/40; C08G 18/32; C08G 18/24; C08G 18/18; C08G 18/16

(52) U.S. Cl. CPC C08G 18/4252; C08J 2203/162; C08J 9/146; C08J 9/0038; C08G 18/7664; C08G 18/6611; C08G 18/6517; C08G 18/485; C08G 18/4829; C08G 18/4816; C08G 18/4211; C08G 18/4018; C08G 18/3206; C08G 18/246; C08G 18/1825; C08G 18/1808; C08G 18/165; C08G 2110/005; C08G 2110/0025; C08J 2375/08; C08J 2375/06; C08J 2207/04; C08K 5/521

(57) ABSTRACT

Described herein are processes for producing a polyurethane foam by mixing the following: (a) polymeric MDI with less than 40% by weight content of difunctional MDI and an aliphatic halogenated hydrocarbon compound (d1) composed of 2 to 5 carbon atoms and of at least one hydrogen atom and of at least one fluorine and/or chlorine atom, where the compound (d1) includes at least one carbon-carbon double bond, to give an isocyanate component (A), and reacting with a polyol component (b) to give the polyurethane foam. Also described herein is a polyurethane foam obtainable by said process.

The present invention relates to the structure of a polyurethane spray foam system, to an industrial process for the production of same, and also to a process for the production of rigid polyurethane foams or rigid polyisocyanurate foams based on said spray foam system.

Numerous publications in the patent literature and other literature describe the known production of polyurethane foams, in particular of rigid polyurethane foams, via reaction of polyisocyanates with a relatively high-molecular-weight compound having at least two reactive hydrogen atoms, in particular with polyether polyols from alkylene oxide polymerization or with polyester polyols from the polycondensation of alcohols with dicarboxylic acids, in the presence of polyurethane catalysts, chain extenders and/or crosslinking agents, blowing agents and other auxiliaries and additional substances.

Polyurethane spray foams are polyurethane foams applied directly in situ by spraying. This also permits by way of example application to vertical areas, and also “overhead” application. The main applications of polyurethane spray foams are found in the construction industry, for example in roof insulation.

Significant requirements placed upon polyurethane spray foams are low thermal conductivity, good fire properties, good flowability, adequate foam adhesion on a very wide variety of substrates and good mechanical properties. The polyurethane foams are usually produced by what is known as the two-component process in which an isocyanate component comprising isocyanates and a polyol component comprising components reactive toward isocyanate are mixed. The other starting materials here, for example blowing agents and catalysts, are usually added to one of the components.

It is known that the polyurethane foam industry uses chemical and/or physical blowing agents to foam the polymer as it forms. Chemical blowing agents are blowing agents that react with the isocyanate function to form a gas, whereas physical blowing agents have a low boiling point and are therefore converted to the gaseous state by the heat of reaction. The chemical, and also the physical, blowing agents here are usually added to the polyol component.

Physical blowing agents mainly used hitherto have comprised chlorofluorocarbons. However, these have now been banned in many parts of the world because of their action in damaging the ozone layer. Physical blowing agents mainly used nowadays comprise fluorinated hydrocarbons, HFCs, and low-boiling-point hydrocarbons, such as pentanes. The shelf life of the respective component is a criterion here.

The hydrocarbons, mainly pentanes, are non-polar and these blowing agents therefore have restricted solubility in polyurethane systems. The polyol component in many polyurethane systems is therefore susceptible to the mixing, and it is therefore advantageous to delay addition of the blowing agent until shortly prior to the foaming procedure, in order to allow for the short shelf life of the blowing-agent-loaded component.

Another problem with the use of alkanes as blowing agent is their combustibility. This combustibility renders alkane-containing polyol components highly combustible even when they have low alkane contents; this imposes particular requirements on processing conditions. The pentane can moreover escape to some extent during the foaming procedure. The resultant explosion risk requires high capital expenditure for safety equipment.

Fluorinated hydrocarbons (HFCs) are used when capital expenditure for said safety equipment to allow use of hydrocarbons as physical blowing agents is excessive, or appropriate apparatuses are not available. HFCs have another advantage over the hydrocarbons: they can provide foams with greater insulating effect. However, HFCs are subject to criticism for environmental reasons because of their contribution to global warming, i.e. their high “global warming potential”, and are therefore also being phased out in the EU by the end of 2022.

Preferred physical blowing agents therefore have low global warming potential. This is the advantage of the halogenated olefins, known as HFOs. A disadvantage of HFO-containing polyol components, particularly of those comprising specific HFOs, for example HFO-1234ze and/or HCFO-1233zd, is the shelf life of the polyol component: even brief storage of the HFO-containing polyol component can lead to a significant change of reaction profile, and to foams with significantly lower quality extending as far as foam collapse. The short shelf life here is caused by decomposition of the blowing agents in the polyol component. This is described by way of example in WO 2009048807. The degradation reaction of HFO blowing agents can be retarded by using specific catalysts, such as imidazole derivatives, but this restricts freedom of formulation, and optimization of catalysis becomes very difficult, if not impossible. The degradation reaction is moreover retarded but not entirely prevented. This is described in the European patent application EP 17153938.0.

It was therefore an object of the invention to develop a polyurethane spray system that permits provision of HFO-based polyurethane systems or HFO-based polyisocyanurate systems with no resultant restriction of freedom in system formulation. A further objective of the present invention was to improve, as far as possible, the shelf life of such systems. The system should also be amenable to very easy and rapid production by way of an environmentally friendly mixing process. In particular, methods were sought here that reduce the cost of production of mixtures of HFO blowing agents and reduce blowing agent losses. The resultant rigid polyurethane foams and rigid polyisocyanurate foams should moreover, as far as possible, have improved mechanical and thermal-insulation properties.

The object is achieved via a process for the production of a polyurethane foam by mixing the following to give a reaction mixture: (a) polymeric MDI with less than 40% by weight content of difunctional MDI, (b) compounds having at least two hydrogen atoms reactive toward isocyanate groups, comprising (b1) at least one polyester polyol and (b2) at least one polyether polyol, (c) optionally flame retardant, (d) blowing agent, comprising at least one aliphatic halogenated hydrocarbon compound (d1) composed of 2 to 5 carbon atoms and of at least one hydrogen atom and of at least one fluorine and/or chlorine atom, where the compound (d1) comprises at least one carbon-carbon double bond, (e) optionally catalyst and (f) optionally auxiliaries and additional substances, spraying the reaction mixture onto a substrate and allowing said reaction mixture to harden to give the polyurethane foam, where an isocyanate component (A) comprising polyisocyanates (a) and blowing agent (d1), and a polyol component (B) comprising compounds (b) having at least two hydrogen atoms reactive toward isocyanate groups are produced, and then isocyanate component (A) and polyol component (B), and also optionally other compounds (c), (e) and (f) are mixed to give the reaction mixture. The object is further achieved via a polyurethane foam obtainable by this process, and also by the use of an isocyanate component (A) comprising polymeric MDI (a) with less than 40% by weight content of difunctional MDI and aliphatic halogenated hydrocarbon compound (d1) composed of 2 to 5 carbon atoms and of at least one hydrogen atom and of at least one fluorine and/or chlorine atom, where the compound (d1) comprises at least one carbon-carbon double bond, and of a polyol component (B) comprising (b1) polyester polyol and (b2) at least one polyether polyol, for the production of polyurethane foams.

The present invention concerns polyurethane spray foams which are applied to the substrate directly in situ by spraying, the substrate being by way of example part of a building, for example a wall or a roof. The polyurethane foam of the invention here is a rigid polyurethane foam. It exhibits a compressive stress at 10% compression that is greater than or equal to 80 kPa, preferably greater than or equal to 120 kPa, particularly preferably greater than or equal to 150 kPa. The closed-cell factor of the rigid polyurethane foam of the invention in accordance with DIN ISO 4590 is moreover above 80%, preferably above 90%. Further details relating to rigid polyurethane foams of the invention are found in “Kunststoffhandbuch, Band 7, Polyurethane” [Plastics handbook, volume 7, Polyurethanes], Carl Hanser Verlag, 3rd edn., 1993, chapter 6, in particular chapter 6.2.7.1 and 6.5.2.5.

For the purposes of the present disclosure, the expressions “polyester polyol” and “polyesterol” are equivalent, as also are the expressions “polyether polyol” and “polyetherol”. Isocyanate (a) used comprises polymeric diphenylmethane diisocyanate. Diphenylmethane diisocyanate is also termed “MDI” hereinafter. Polymeric MDI is a mixture of MDI comprising two rings with MDI homologs comprising a larger number of rings, for example homologs comprising 3, 4 or 5 rings, i.e. with 3-, 4- or 5-functional isocyanates. Polymeric MDI can be used together with other diisocyanates conventionally used in polyurethane chemistry, for example toluene diisocyanate (TDI) or naphthalene diisocyanate (NDI). It is essential here in the invention that the content of aromatic diisocyanates is at most 40% by weight, preferably at most 38% by weight, more preferably at most 35% by weight, particularly preferably at most 33% by weight and in particular at most 31% by weight, based in each case on the total weight of diisocyanates and of MDI homologs having a larger number of rings. The content of diisocyanates is preferably at least 10% by weight, particularly preferably at least 20% by weight and in particular at least 25% by weight, based on the total weight of diisocyanates and of MDI homologs having a larger number of rings. The diisocyanates preferably comprise at least 80% by weight of diphenylmethane diisocyanate, particularly preferably at least 90% by weight of diphenylmethane diisocyanate and in particular exclusively diphenylmethane diisocyanate, based in each case on the total weight of the diisocyanates. The viscosity of the polyisocyanates (a) here at 25° C. is preferably 250 mPas to 1000 mPas, more preferably 300 mPas to 800 mPas, particularly preferably 400 mPas to 700 mPas and in particular 450 mPas to 550 mPas.

Compounds (b) used having groups reactive toward isocyanates can comprise all known compounds having at least two hydrogen atoms reactive toward isocyanates, for example those with functionality 2 to 8 and with number-average molar mass 62 to 15 000 g/mol: by way of example, it is possible to use compounds selected from the group of the polyether polyols, polyester polyols and mixtures thereof. The molar mass of polyetherols and polyesterols is preferably 150 to 15 000 g/mol. It is also possible to use low-molecular-weight chain extenders and/or crosslinking agents, alongside polyetherols and polyesterols.

Polyetherols are by way of example produced from epoxides, for example propylene oxide and/or ethylene oxide, or from tetrahydrofuran, by using starter compounds having active hydrogen, for example aliphatic alcohols, phenols, amines, carboxylic acids, water or compounds based on natural materials, for example sucrose, sorbitol or mannitol, with use of a catalyst. Mention may be made here of basic catalysts or double-metal cyanide catalysts, as described by way of example in PCT/EP2005/010124, EP 90444 or WO 05/090440.

Polyesterols are by way of example produced from aliphatic or aromatic dicarboxylic acids and from polyhydric alcohols, polythioether polyols, polyesteramides, hydroxylated polyacetals and/or hydroxylated aliphatic polycarbonates, preferably in the presence of an esterification catalyst. Other possible polyols are listed by way of example in “Kunststoffhandbuch, Band 7, Polyurethane” [Plastics Handbook, volume 7, Polyurethanes], Carl Hanser Verlag, 3rd edition 1993, chapter 3.1.

The compounds (b) having at least two hydrogen atoms reactive toward isocyanate groups comprise, in the invention, (b1) at least one polyester polyol and (b2) at least one polyether polyol.

Suitable polyester polyols (b1) can be produced from organic dicarboxylic acids having from 2 to 12 carbon atoms, preferably aromatic, or from mixtures of aromatic and aliphatic dicarboxylic acids with polyhydric alcohols, preferably diols, having 2 to 12 carbon atoms, preferably 2 to 6 carbon atoms.

Dicarboxylic acids used can in particular comprise the following: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used here either individually or else in a mixture. It is also possible to use, instead of the free dicarboxylic acids, the corresponding dicarboxylic acid derivatives, for example dicarboxylic esters of alcohols having 1 to 4 carbon atoms or dicarboxylic anhydrides. Aromatic dicarboxylic acids used preferably comprise phthalic acid, phthalic anhydride, terephthalic acid and/or isophthalic acid in a mixture or alone. Aliphatic dicarboxylic acids used preferably comprise dicarboxylic acid mixtures of succinic, glutaric and adipic acid in quantitative proportions of by way of example 20 to 35:35 to 50:20 to 32 parts by weight, and in particular adipic acid. Examples of di- and polyhydric alcohols, in particular diols, are: ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane and pentaerythritol. It is preferable to use ethanediol, diethylene glycol, 1,4-butanediol, 1,5-pentanediol, 1,6-hexanediol or a mixture of at least two of the diols mentioned, in particular a mixture of 1,4-butanediol, 1,5-pentanediol and 1,6-hexanediol. It is also possible to use polyester polyols derived from lactones, for example 8-caprolactone, or hydroxycarboxylic acids, e.g. w-hydroxycaproic acid.

It is also possible to use biobased starter materials and/or derivatives thereof for the production of the polyester polyols, examples being castor oil, polyhydroxy fatty acids, ricinoleic acid, hydroxy-modified oils, grapeseed oil, black cumin oil, pumpkin seed oil, borage seed oil, soybean oil, wheatgerm oil, rapeseed oil, sunflower seed oil, peanut oil, apricot kernel oil, pistachio nut oil, almond oil, olive oil, macadamia nut oil, avocado oil, sea buckthorn oil, sesame oil, hemp oil, hazelnut oil, evening primrose oil, wild rose oil, safflower oil, walnut oil, fatty acids, hydroxy-modified fatty acids and fatty acid esters based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid and cervonic acid.

The polyester polyols (b1) preferably comprise at least one polyesterol (b1a) obtainable via esterification of

(b1a1) 10 to 80 mol % of a dicarboxylic acid composition comprising
(b1a11) 20 to 100 mol %, based on the dicarboxylic acid composition, of one or more aromatic dicarboxylic acids or derivatives of same,
(b1a12) 0 to 80 mol %, based on the dicarboxylic acid composition, of one or more aliphatic dicarboxylic acids or derivatives of same, (b1a2) 0 to 30 mol % of one or more fatty acids and/or fatty acid derivatives,
   (b1a3) 2 to 70 mol % of one or more aliphatic or cycloaliphatic diols having 2 to 18 carbon atoms or alkoxylates of same,
   (b1a4) greater than 0 to 80 mol % of an alkoxylation product of at least one starter molecule with average functionality at least two, based in each case on the total quantity of components (b1a1) to (b1a4), where components (b1a1) to (b1a4) give a total of 100 mol %.

Component Wall) preferably comprises at least one compound selected from the group consisting of terephthalic acid, dimethyl terephthalate (DMT), polyethylene terephthalate

(PET), phthalic acid, phthalic anhydride (PA) and isophthalic acid. Component b1a1) particularly preferably comprises at least one compound from the group consisting of terephthalic acid, dimethyl terephthalate (DMT), polyethylene terephthalate (PET) and phthalic anhydride (PA). Component b1a11) very particularly preferably comprises phthalic anhydride, dimethyl terephthalate (DMT), terephthalic acid or a mixture thereof. The aromatic dicarboxylic acids or derivatives thereof of component Mal) are particularly preferably selected from the abovementioned aromatic dicarboxylic acids or dicarboxylic acid derivatives and specifically from terephthalic acid and/or dimethyl terephthalate (DMT). Terephthalic acid and/or DMT in component b1a11) leads to specific polyesters b1a) based on at least one polyether with particularly good fire-protection properties.

The quantity present of aliphatic dicarboxylic acids or corresponding derivatives (component b1a12) is in the dicarboxylic acid composition b1a12) generally 0 to 50 mol %, preferably 0 to 30 mol %, particularly preferably 0 to 20 mol % and more specifically 0 to 10 mol %. The dicarboxylic acid composition b1a12) specifically comprises no aliphatic dicarboxylic acids or derivatives of same, and therefore consists of 100 mol % of one or more aromatic dicarboxylic acids or derivatives thereof b1a11), preference being given to the abovementioned.

In one embodiment of the invention, the fatty acid or the fatty acid derivative W1a2) consists of a fatty acid or fatty acid mixture, one or more glycerol esters of fatty acids or of fatty acid mixtures and/or one or more fatty acid monoesters, for example biodiesel or methyl esters of fatty acids; it is particularly preferable that component b1a2) consists of a fatty acid or fatty acid mixture and/or one or more fatty acid monoesters; more specifically, component b1a2) consists of a fatty acid or fatty acid mixture and/or biodiesel, and specifically component b1a2) consists of a fatty acid or fatty acid mixture.

In a preferred embodiment of the invention, the fatty acid or the fatty acid derivative b1a2) is selected from the group consisting of castor oil, polyhydroxy fatty acids, ricinoleic acid, stearic acid, hydroxy-modified oils, grapeseed oil, black cumin oil, pumpkin seed oil, borage seed oil, soybean oil, wheatgerm oil, rapeseed oil, sunflower seed oil, peanut oil, apricot kernel oil, pistachio nut oil, almond oil, olive oil, macadamia nut oil, avocado oil, sea buckthorn oil, sesame oil, hemp oil, hazelnut oil, evening primrose oil, wild rose oil, safflower oil, walnut oil, animal tallow, for example beef tallow, fatty acids, hydroxy-modified fatty acids, biodiesel, methyl esters of fatty acids and fatty acid esters based on myristoleic acid, palmitoleic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid and cervonic acid, and also mixed fatty acids.

In a particularly preferred embodiment of the present invention, the fatty acid or the fatty acid derivative b1a2) is oleic acid, biodiesel, soy oil, rapeseed oil or tallow, particularly preferably oleic acid, biodiesel, soy oil, rapeseed oil or beef tallow, more specifically oleic acid or biodiesel and especially oleic acid. The fatty acid or the fatty acid derivative improves inter alia blowing agent solubility in the production of rigid polyurethane foams.

It is very particularly preferable that component b1a2) comprises no triglyceride, in particular no oil or fat. As mentioned above, the glycerol liberated from the triglyceride through esterification or transesterification impairs the dimensional stability of the rigid foam. Preferred fatty acids and fatty acid derivatives for the purposes of component b2) are therefore the fatty acids themselves, and also alkyl monoesters of fatty acids or alkyl monoesters of fatty acid mixtures, in particular the fatty acids themselves and/or biodiesel.

It is preferable that the aliphatic or cycloaliphatic diol b1a3) is selected from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentanediol and alkoxylates of these. It is particularly preferable that the aliphatic diol b1a3) is monoethylene glycol or diethylene glycol, in particular diethylene glycol.

The functionality of the polyol b1a4) is preferably greater than or equal to 2.7, in particular greater than or equal to 2.9. Its functionality is generally less than or equal to 6, preferably less than or equal to 5, particularly preferably less than or equal to 4.

In a preferred embodiment, the polyol b1a4) is selected from the group consisting of alkoxylates of sorbitol, pentaerythritol, trimethylolpropane, glycerol, polyglycerol and mixtures of these.

In a preferred embodiment, the polyol b1a4) is an alkoxylate of the polyols mentioned obtainable via alkoxylation with ethylene oxide or propylene oxide, preferably ethylene oxide; the resultant rigid polyurethane foams have improved fire-protection properties.

In a particularly preferred embodiment of the present invention, component b1a4) is produced via anionic polymerization of propylene oxide or ethylene oxide, preferably ethylene oxide, in the presence of alkoxylation catalysts such as alkali metal hydroxides, for example sodium hydroxide or potassium hydroxide, or of alkali metal alcoholates, for example sodium methanolate, sodium ethanolate or potassium ethanolate or potassium isopropanolate, or of aminic alkoxylation catalysts such as dimethylethanolamine (DMEOA), imidazole and imidazole derivatives, and also mixtures thereof, with use of the starter molecule. Preferred alkoxylation catalysts here are KOH and aminic alkoxylation catalysts. When KOH is used as alkoxylation catalyst it is first necessary to neutralize the polyether, and the resultant potassium salt must be removed before the polyether can be used as component B14) in the esterification, and therefore preference is given to use of aminic alkoxylation catalysts. Preferred aminic alkoxylation catalysts are selected from the group comprising dimethylethanolamine (DMEOA), imidazole and imidazole derivatives, and also mixtures thereof, particularly preferably imidazole.

The OH number of the polyether polyol b1a4) is preferably greater than or equal to 100 mg KOH/g, with preference greater than or equal to 200 mg KOH/g, with particular preference greater than or equal to 300 mg KOH/g, more specifically greater than or equal to 400 mg KOH/g, especially greater than or equal to 500 mg KOH/g, and specifically greater than or equal to 600 mg KOH/g.

The OH number of the polyether polyol b1a4) is moreover preferably less than or equal to 1800 mg KOH/g, more preferably less than or equal to 1400 mg KOH/g, particularly preferably less than or equal to 1200 mg KOH/g, more specifically less than or equal to 1000 mg KOH/g, especially less than or equal to 800 mg KOH/g, and specifically less than or equal to 700 mg KOH/g.

Quantities used of component Mal) are preferably 20 to 70 mol %, particularly preferably 25 to 50 mol %, based on the entirety of components b1a1) to b1a4).

Quantities used of component b1a2) are preferably 0.1 to 28 mol %, particularly preferably 0.5 to 25 mol %, more specifically 1 to 23 mol %, still more specifically 1.5 to 20 mol %, specifically 2 to 19 mol % and especially 5 to 18 mol %, based on the entirety of components b1a1) to b1a4).

Quantities used of component b1a3) are preferably 5 to 60 mol %, with preference 10 to 55 mol %, with particular preference 25 to 45 mol %, based on the entirety of components b1a1) to b1a4).

Quantities used of component b1a4) are preferably 2 to 70 mol %, with preference 5 to 60 mol %, with particular preference 7 to 50 mol %, based on the entirety of components WO to b1a4).

The quantity used of component b1a4) per kg of polyester polyol of component WI a) is preferably at least 200 mmol, particularly preferably at least 400 mmol, with particular preference at least 600 mmol, with especial preference at least 800 mmol, especially at least 1000 mmol.

The number-average functionality of a polyester polyol of component WI a) is preferably greater than or equal to 2, with preference greater than 2, with particular preference greater than 2.2 and in particular greater than 2.3; the polyurethane produced therewith has higher crosslinking density, and the polyurethane foam therefore has better mechanical properties.

For the production of the polyester polyols, the aliphatic and aromatic polycarboxylic acids and/or polycarboxylic acid derivatives and polyhydric alcohols can be polycondensed without catalyst or preferably in the presence of esterification catalysts, advantageously in an atmosphere of inert gas such as nitrogen, in the melt, at temperatures of 150 to 280° C., preferably 180 to 260° C., optionally under reduced pressure until the desired acid number has been reached, this advantageously being below 10, preferably below 2. In a preferred embodiment, the esterification mixture is polycondensed at the abovementioned temperatures as far as an acid number of 80 to 20, preferably 40 to 20, under atmospheric pressure and then under a pressure below 500 mbar, preferably 40 to 400 mbar. Examples of esterification catalysts that can be used are iron catalysts, cadmium catalysts, cobalt catalysts, lead catalysts, zinc catalysts, antimony catalysts, magnesium catalysts, titanium catalysts and tin catalysts in the form of metals, of metal oxides or of metal salts. The polycondensation can, however, also be carried out in liquid phase in the presence of diluents and/or entraining agents, e.g. benzene, toluene, xylene or chlorobenzene, for azeotropic removal by distillation of the water of condensation.

For the production of the polyester polyols, the organic polycarboxylic acids and/or polycarboxylic acid derivatives and polyhydric alcohols are advantageously polycondensed in a molar ratio of 1:1 to 2.2, preferably 1:1.05 to 2.1 and particularly preferably 1:1.1 to 2.0.

The number-average molecular weight of the resultant polyester polyols is generally 300 to 3000, preferably 400 to 1000 and in particular 450 to 800.

Component (b) moreover preferably comprises, alongside the polyester polyol (b1a), a polyester polyol (b1 b), where the polyester polyol (b1 b) is produced in the absence of component (b1a4). It is preferable that the polyester polyol (b1b) is obtained by a method analogous to that for the polyester polyol (b1a), where non-alkoxylated alcohols (b1 b4) with a functionality of 3 or more are used instead of component (b1a4). Alcohols (b1 b4) used particularly preferably comprise alcohols selected from the group consisting of sorbitol, pentaerythritol, trimethylolpropane, glycerol and polyglycerol.

The ratio by mass of the polyester polyols (b1a) to the polyesterols (b1b) is preferably at least 0.25, more preferably at least 0.5, particularly preferably at least 0.8; in particular, no component (b1b) is used.

The polyetherols (b2) are obtained by known methods, for example by anionic polymerization, in the presence of catalysts, of alkylene oxides with addition of at least one starter molecular comprising 2 to 8, preferably 2 to 6, reactive hydrogen atoms. Fractional functionalities can be obtained by using mixtures of starter molecules with different functionality. The nominal functionality ignores effects on functionality due by way of example to side reactions. Catalysts used can comprise alkali metal hydroxides, for example sodium hydroxide or potassium hydroxide, or alkali metal alcoholates, for example sodium methanolate, sodium ethanolate or potassium ethanolate or potassium isopropanolate, or in the case of cationic polymerization Lewis acids as catalysts, for example antimony pentachloride, boron trifluoride etherate or bleaching earth. It is also possible to use aminic alkoxylation catalysts, for example dimethylethanolamine (DMEOA), imidazole and imidazole derivatives. Catalysts used can moreover also comprise double-metal cyanide compounds, known as DMC catalysts.

Alkylene oxides used preferably comprise one or more compounds having 2 to 4 carbon atoms in the alkylene moiety, for example tetrahydrofuran, propylene 1,2-oxide, ethylene oxide, or butylene 1,2- or 2,3-oxide, in each case alone or in the form of mixtures. It is preferable to use ethylene oxide and/or propylene 1,2-oxide.

The following can be used as starter molecules: compounds containing hydroxy groups or containing amine groups, for example ethylene glycol, diethylene glycol, glycerol, trimethylolpropane, pentaerythritol, sugar derivatives such as sucrose, hexitol derivatives such as sorbitol, methylamine, ethylamine, isopropylamine, butylamine, benzylamine, aniline, toluidine, toluenediamine (TDA), naphthylamine, ethylenediamine, diethylenetriamine, 4,4′-methylenedianiline, 1,3-propanediamine, 1,6-hexanediamine, ethanolamine, diethanolamine, triethanolamine, and also other dihydric or polyhydric alcohols or monofunctional or polyfunctional amines. Under the usual reaction conditions of alkoxylation, these highly functional compounds are in solid form, and these are generally therefore alkoxylated together with co-initiators. Examples of co-initiators are water, lower polyhydric alcohols, e.g. glycerol, trimethylolpropane, pentaerythritol, diethylene glycol, ethylene glycol, propylene glycol and homologs of these. Examples of other co-initiators that can be used are: organic fatty acids, fatty acid monoesters and fatty acid methyl esters, e.g. oleic acid, stearic acid, methyl oleate, methyl stearate and biodiesel; these serve to improve blowing agent solubility in the production of rigid polyurethane foams.

Preferred starter molecules for the production of the polyether polyols (b2) are sorbitol, sucrose, ethylenediamine, TDA, trimethylolpropane, pentaerythritol, glycerol, biodiesel and diethylene glycol. Particularly preferred starter molecules are sucrose, glycerol, biodiesel, TDA and ethylenediamine, in particular sucrose, ethylenediamine and/or tolylendiamine.

The functionality of the polyether polyols used for the purposes of component (b2) is preferably 2 to 6 and in particular 2.5 to 5.5, their number-average molar masses being preferably 150 to 3000 g/mol, particularly preferably 150 to 1500 g/mol and in particular 250 to 800 g/mol. The OH number of the polyether polyols of component (b1) is preferably 1200 to 100 mg KOH/g, preferably 1000 to 200 mg KOH/g and in particular 800 to 350 mg KOH/g.

Component (b) can moreover comprise chain extenders and/or crosslinking agents, for example in order to modify mechanical properties, e.g. hardness. Chain extenders and/or crosslinking agents used comprise diols and/or triols, and also aminoalcohols having molar masses below 150 g/mol, preferably 60 to 130 g/mol. Examples of those that can be used are aliphatic, cycloaliphatic and/or araliphatic diols having 2 to 8, preferably 2 to 6, carbon atoms, e.g. ethylene glycol, propylene 1,2-glycol, diethylene glycol, dipropylene glycol, 1,3-propanediol, 1,4-butanediol, 1,6-hexanediol, o-, m-, p-dihydroxycyclohexane, bis(2-hydroxyethyl)hydroquinone. It is equally possible to use aliphatic and cycloaliphatic triols such as glycerol, trimethylolpropane and 1,2,4- and 1,3,5-trihydroxycyclohexane.

Insofar as chain extenders, crosslinking agents or mixtures thereof are used for the production of the rigid polyurethane foams, quantities advantageously used of these are 0 to 15% by weight, preferably 0 to 5% by weight, based on the total weight of component (B). Component (B) preferably comprises less than 2% by weight of chain extenders and/or crosslinking agents, particularly preferably less than 1% by weight and in particular does not comprise chain extenders and/or crosslinking agents.

The ratio by mass of the entirety of components (b1) to the entirety of components (b2) is preferably below 7, particularly below 5, with preference below 4, with particular preference below 3, in particular with preference below 2, with especial preference below 1.7 and with very particular preference below 1.5. The inventive ratio by mass of the entirety of components (b1) to the entirety of components (b2) is moreover above 0.1, preferably above 0.2, in particular above 0.2, preferably above 0.4, particularly preferably above 0.5, especially preferably above 0.8 and very particularly preferably above 1.

Flame retardants (c) used can generally comprise the flame retardants known from the prior art. Examples of suitable flame retardants are brominated esters, brominated ethers (Ixol) and brominated alcohols such as dibromoneopentyl alcohol, tribromoneopentyl alcohol and PHT-4-diol, and also chlorinated phosphates such as tris(2-chloroethyl) phosphate, tris(2-chloropropyl) phosphate (TCPP), tris(1,3-dichloropropyl) phosphate, tricresyl phosphate, tris(2,3-dibromopropyl) phosphate, tetrakis(2-chloroethyl) ethylenediphosphate, dimethyl methanephosphonate, diethyl diethanolaminomethylphosphonate, and also commercially available halogenated flame-retardant polyols. Other phosphates or phosphonates used can comprise diethyl ethanephosphonate (DEEP), triethyl phosphate (TEP), dimethyl propylphosphonate (DMPP), and diphenyl cresyl phosphate (DPC) as liquid flame retardants.

Materials that can also be used other than the abovementioned flame retardants to provide flame retardancy to the rigid polyurethane foams are inorganic or organic flame retardants such as red phosphorus, preparations comprising red phosphorus, aluminum oxide hydrate, antimony trioxide, arsenic oxide, ammonium polyphosphate and calcium sulfate, expandable graphite and cyanuric acid derivatives, e.g. melamine, and mixtures of at least two flame retardants, e.g. ammonium polyphosphates and melamine, and also optionally maize starch or ammonium polyphosphate, melamine and expandable graphite; aromatic polyesters can optionally also be used for this purpose.

Preferred flame retardants do not include any bromine. Particularly preferred flame retardants consist of atoms selected from the group consisting of carbon, hydrogen, phosphorus, nitrogen, oxygen and chlorine, more especially from the group consisting of carbon, hydrogen, phosphorus and chlorine.

Preferred flame retardants comprise no groups reactive toward isocyanate groups. It is preferable that the flame retardants are liquid at room temperature. Particular preference is given to TCPP, DEEP, TEP, DMPP and DPC, in particular TCPP.

The proportion of the flame retardant (c), insofar as component (c) is used in the mixture of components (b) to (f), is generally 5 to 40% by weight, preferably 8 to 30% by weight, particularly preferably 10 to 25% by weight, based on the total weight of components (b) to (g).

At least one blowing agent (d) is used in the invention. This comprises at least one aliphatic halogenated hydrocarbon compound (d1) composed of 2 to 5, preferably 3 or 4, carbon atoms and of at least one hydrogen atom and of at least one fluorine and/or chlorine atom, where the compound (d1) comprises at least one carbon-carbon double bond. Suitable compounds (d1) comprise trifluoropropenes and tetrafluoropropenes, for example (HFO-1234), pentafluoropropenes, for example (HFO-1225), chlorotrifluoropropenes, for example (HFO-1233), chlorodifluoropropenes and chlorotetrafluoropropenes, and also mixtures of one or more of these components. Particular preference is given to tetrafluoropropenes, pentafluoropropenes and chlorotrifluoropropenes where the unsaturated terminal carbon atom bears more than one chlorine substituent or fluorine substituent. Examples are 1,3,3,3-tetrafluoropropene (HFO-1234ze); 1,1,3,3-tetrafluoropropene; 1,2,3,3,3-pentafluoropropene (HFO-1225ye); 1,1,1-trifluoropropene; 1,1,1,3,3-pentafluoropropene (HFO-1225zc); 1,1,1,3,3,3-hexafluorobut-2-ene, 1,1,2,3,3-pentafluoropropene (HFO-1225yc); 1,1,1,2,3-pentafluoropropene (HFO-1225yez); 1-chloro-3,3,3-trifluoropropene (HCFO-1233zd); 1,1,1,4,4,4-hexafluorobut-2-ene and mixtures of two or more of these components.

Particularly preferred compounds (d1) are hydroolefins selected from the group consisting of trans-1-chloro-3,3,3-trifluoropropene (HCFO-1233zd(E)), cis-1-chloro-3,3,3-trifluoropropene (HCFO-1233zd(Z)), trans-1,1,1,4,4,4-hexafluorobut-2-ene (HFO1336mzz(E)), cis-1,1,1,4,4,4-hexafluorobut-2-ene (HFO-1336mzz(Z)), trans-1,3,3,3-tetrafluoroprop-1-ene (HFO-1234ze(E)), cis-1,3,3,3-tetrafluoroprop-1-ene (HFO-1234ze(Z)) and mixtures of one or more components thereof.

Among the blowing agents that can be used for the production of the polyurethane foams of the invention are moreover preferably water, formic acid and mixtures thereof. These react with isocyanate groups with formation of carbon dioxide and in the case of formic acid to give carbon dioxide and carbon monoxide. These blowing agents are termed chemical blowing agents because they liberate gas through a chemical reaction with the isocyanate groups. It is also possible to use physical blowing agents, for example low-boiling-point hydrocarbons. Suitable materials are in particular liquids which are inert toward the isocyanates used and have boiling points below 100° C., preferably below 50° C., at atmospheric pressure, and which therefore evaporate when subjected to the exothermic polyaddition reaction. Examples of these liquids preferably used are aliphatic and cycloaliphatic hydrocarbons having 4 to 8 carbon atoms, for example heptane, hexane, and isopentane, preferably technical mixtures of n- and isopentanes, n- and isobutane and propane, cycloalkanes, for example cyclopentane and/or cyclohexane, ethers, for example furan, dimethyl ether and diethyl ether, ketones, for example acetone and methyl ethyl ketone, alkyl carboxylates, for example methyl formate, dimethyl oxalate and ethyl acetate, and halogenated hydrocarbons, for example methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane and heptafluoropropane. It is also possible to use mixtures of these low-boiling-point liquids with one another and/or with other substituted or unsubstituted hydrocarbons.

For the purposes of the present invention, the expression physical blowing agents (d2) is used here for physical blowing agents not covered by the definition (d1). The expression chemical blowing agents (d3) is used for chemical blowing agents.

Suitable chemical blowing agents (d3) moreover comprise organic carboxylic acids, e.g. formic acid, acetic acid, oxalic acid, ricinoleic acid, and compounds containing carboxy groups. It is preferable that blowing agents used do not comprise any halogenated hydrocarbons other than the compounds (d1). It is preferable that chemical blowing agents (d3) used comprise water, formic-acid-water mixtures or formic acid; particularly preferred chemical blowing agents are water and formic-acid-water mixtures.

It is preferable that at least one chemical blowing agent (d3) is used alongside component (d1).

The quantity used of the blowing agent or of the blowing agent mixture is generally 1 to 30% by weight, preferably 1.5 to 20% by weight, particularly preferably 2.0 to 15% by weight, based in each case on the entirety of components (b) to (f). If water, or a formic-acid-water mixture, is used as blowing agent, the quantity thereof added to component (B) is preferably 0.2 to 6% by weight, based on the total weight of component (b).

Compounds used as catalysts (e) for the production of the polyurethane foams in particular comprise compounds that greatly accelerate the reaction between the polyisocyanates (a) and the compounds of components (b) to (f) comprising reactive hydrogen atoms, in particular comprising hydroxy groups.

It is advantageous to use basic polyurethane catalysts, for example tertiary amines, examples being triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis(2-dimethylaminoethyl) ether, dimethylpiperazine, N-dimethylaminoethylpiperidine, 1,2-dimethylimidazole, 1-azabicyclo[2.2.0]octane, 1,4-diazabicyclo[2.2.2]octane (Dabco), and alkanolamine compounds, for example triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, and triethylenediamine. However, other suitable compounds are metal salts, for example iron(II) chloride, zinc chloride, lead octanoate, and preferably tin salts, for example tin dioctanoate, tin diethylhexanoate, and dibutyltin dilaurate, and in particular mixtures of tertiary amines and of organotin salts.

The following can also be used as catalysts: amidines, for example 2,3-dimethyl-3,4,5,6-tetrahydropyrimidine, tetraalkylammonium hydroxides, for example tetramethylammonium hydroxide, alkali metal hydroxides, for example sodium hydroxide, and alkali metal alcoholates, for example sodium methanolate and sodium isopropanolate, alkali metal carboxylates, and also alkali metal salts of long-chain fatty acids having 10 to 20 carbon atoms and optionally having pendant OH groups.

It is moreover possible to use incorporable amines as catalysts, i.e. preferably amines having an OH, NH or NH2 function, examples being ethylenediamine, triethanolamine, diethanolamine, ethanolamine and dimethylethanolamine.

It is preferable to use 0.001 to 10 parts by weight of catalyst or of catalyst combination, based on 100 parts by weight of component (b). It is also possible to carry out the reactions without catalysis. In this case, it is usual to utilize the catalytic activity of amine-started polyols.

If an excess of polyisocyanate is used during the foaming procedure, the following can moreover be used as catalysts for the trimerization reaction between the excess NCO groups: catalysts that form isocyanurate groups, for example salts of ammonium ions or of alkali metals, especially ammonium carboxylates or alkali metal carboxylates, alone or in combination with tertiary amines. Formation of isocyanurate leads to flame-retardant PIR foams which are preferably used in rigid foam for technical applications, for example in the construction industry as insulation sheet or sandwich elements.

In a preferred embodiment of the invention, a portion of component (e) consists of tin salts, for example tin dioctanoate, tin diethylhexanoate and dibutyltin dilaurate.

It is also optionally possible to add further auxiliaries and/or additional substances (f) to the reaction mixture for the production of the polyurethane foams of the invention. Mention may be made by way of example of surface-active substances, foam stabilizers, cell regulators, fillers, light stabilizers, dyes, pigments, hydrolysis stabilizers, and substances having fungistatic and bacteriostatic action.

Examples of surface-active substances that can be used are compounds which serve to support homogenization of the starting materials and which optionally are also suitable for regulating the cell structure of the plastics. Mention may be made by way of example of emulsifiers, for example the sodium salts of castor oil sulfates and of fatty acids and salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid; foam stabilizers, for example siloxane-oxyalkylene copolymers and other organopolysiloxanes, ethoxylated alkylphenols, ethoxylated fatty alcohols, paraffin oils, castor oil esters or ricinoleic esters, turkey red oil and peanut oil, and cell regulators, for example paraffins, fatty alcohols and dimethylpolysiloxanes. Other materials suitable for improving emulsifying action and cell structure and/or foam stabilization are the oligomeric acrylates described above having, as pendant groups, polyoxyalkylene moieties and fluoroalkane moieties. Quantities usually used of the surface-active substances are 0.01 to 10 parts by weight, based on 100 parts by weight of component (b).

Foam stabilizers used can comprise conventional foam stabilizers, for example those based on silicone, examples being siloxane-oxyalkylene copolymers and other organopolysiloxanes and/or ethoxylated alkylphenols and/or ethoxylated fatty alcohols.

Light stabilizers used can comprise light stabilizers known in polyurethane chemistry. These comprise phenolic stabilizers, for example 3,5-di-tert-butyl-4-hydroxytoluenes and/or Irganox products from BASF, phosphites, for example triphenylphosphites and/or tris(nonylphenyl) phosphites, UV absorbers, for example 2-(2-hydroxy-5-methylphenyl)benzotriazoles, 2-(5-chloro-2H-benzotriazol-2-yl)-6-(1,1-dimethylethyl)-4-methylphenol, 2-(2H-benzotriazol-2-yl)-6-dodecyl-4-methylphenol, branched and linear, and 2,2′-(2,5-thiophenediyl)bis[5-tert-butylbenzoxazoles], and also those known as HALS stabilizers (hindered amine light stabilizers), for example bis(1-octyloxy-2,2,6,6-tetramethyl-4-piperidinyl) sebacate, n-butyl-(3,5-di-tert-butyl-4-hydroxybenzyl)bis(1,2,2,6-pentamethyl-4-piperidinyl) malonate and diethyl succinate polymer with 4-hydroxy-2,2,6,6-tetramethyl-1-piperidineethanol.

The term fillers, in particular reinforcing fillers, means the conventional organic and inorganic fillers, reinforcing agents, weighting agents, and agents for improving abrasion behavior in paints, coating compositions, etc., these being known per se. Individual examples that may be mentioned are: inorganic fillers such as silicatic minerals, for example phyllosilicates such as antigorite, serpentine, hornblends, amphiboles, chrysotile and talc, metal oxides, for example kaolin, aluminum oxides, titanium oxides and iron oxides, metal salts, for example chalk, barite, and inorganic pigments, for example cadmium sulfide and zinc sulfide, and also glass, etc. It is preferable to use kaolin (china clay), aluminum silicate and coprecipitates of barium sulfate and aluminum silicate, and also natural and synthetic fibrous minerals, for example wollastonite, and fibers of various lengths made of metal and in particular of glass; these can optionally have been sized. Examples of organic fillers that can be used are: carbon, melamine, colophony, cyclopentadienyl resins and graft polymers, and also cellulose fibers, polyamide fibers, polyacrylonitrile fibers, polyurethane fibers and polyester fibers derived from aromatic and/or aliphatic dicarboxylic esters, and in particular carbon fibers.

The inorganic and organic fillers can be used individually or in the form of mixtures, quantities of these added to the reaction mixture advantageously being 0.5 to 50% by weight, preferably 1 to 40% by weight, based on the weight of components (a) to (f), where however the content of mats, nonwovens and wovens made of natural and synthetic fibers can reach up to 80% by weight, based on the weight of components (a) to (f).

The polyurethane foams are produced in the invention via mixing of an isocyanate component (A) comprising polyisocyanates (a) and blowing agent (d1) with a polyol component (B) comprising compounds (b) having at least two hydrogen atoms reactive toward isocyanate groups to give a reaction mixture and allowing the reaction mixture to complete its reaction to give the polyurethane foam. The expression reaction mixture here means for the purposes of the present invention the mixture of the isocyanates (a) with the compounds (b) reactive toward isocyanate when the action conversions are below 90%, based on the isocyanate groups. It is preferable here to use the two-component process where all of the starting materials (a) to (f) are present either in the isocyanate component (A) or in the polyol component (B). It is preferable here that all of the substances that can react with isocyanate are added to the polyol component (B), while starting materials not reactive toward isocyanates can be added either to the isocyanate component (A) or to the polyol component (B). If any other additives at all are added alongside the blowing agent to the isocyanate mixture, the average OH number of these is preferably <100 mg KOH/g, particularly preferably <50 mg KOH/g, more especially <10 mg KOH/g. It is particularly preferable that additives added to isocyanate component (A) are only those bearing no functional groups that react with the NCO function of the isocyanate, i.e. the only additives used are those that are inert in relation to the isocyanate.

The proportion of the isocyanates (a), based on isocyanate component (A), is preferably above 10% by weight, more preferably above 50% by weight, particularly preferably above 70% by weight, with further preference above 80% by weight and in particular above 90% by weight, based in each case on the total weight of isocyanate component (A).

The proportion of component (d1), based on isocyanate component (A), is preferably above 0.5% by weight, more preferably above 1% by weight, particularly preferably above 3% by weight, with further preference above 5% by weight, with still further preference above 7% by weight and in particular above 9% by weight, based in each case on the total weight of isocyanate component (A). The proportion of component (d1), based on isocyanate component (a) is moreover preferably below 50% by weight, more preferably below 30% by weight, particularly preferably below 25% by weight, with further preference below 20% by weight, with still further preference below 15% by weight and in particular below 12% by weight, based in each case on the total weight of the isocyanate component (A).

If further physical blowing agents (d2) are used, these can likewise be added to isocyanate component (A). The proportion of component (d2), based on isocyanate component (A), is preferably below 50% by weight, more preferably below 30% by weight, still more preferably below 20% by weight, particularly preferably below 15% by weight and in particular below 10% by weight. In a particularly preferred embodiment, no chemical blowing agent (d3) is added to isocyanate component (A).

If any other additives at all are added alongside the blowing agent to the isocyanate component (A), the average OH number of these is preferably <100 mg KOH/g, particularly preferably <50 mg KOH/g, more especially <10 mg KOH/g. Additives used are especially only those bearing no functional groups that react with the NCO function of the isocyanate, i.e. the only additives used are those that are inert in relation to the isocyanate.

Isocyanate component (A) in a preferred embodiment comprises, alongside the isocyanates (a) and the blowing agents (d1) and optionally (d2), one or more surface-active substances which improve the solubility of the blowing agents (d1) in the polyisocyanates. Compounds that can be used here are mainly those that serve to promote homogenization of the starting materials and that are optionally also suitable for regulating the cell structure of the plastics. Mention may be made by way of example of emulsifiers, for example the sodium salts of castor oil sulfates or of fatty acids, and also salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid; foam stabilizers, for example siloxane-oxyalkylene copolymers and other organopolysiloxanes, ethoxylated alkylphenols, ethoxylated fatty alcohols, paraffin oils, castor oil esters or ricinoleic esters, turkey red oil and peanut oil, and cell regulators, for example paraffins, fatty alcohols and dimethylpolysiloxanes. Other materials suitable for improving emulsifying action and cell structure and/or foam stabilization are the oligomeric acrylates described above having, as pendant groups, polyoxyalkylene moieties and fluoroalkane moieties. Particular preference is given to use of foam stabilizers such as siloxane-oxyalkylene copolymers and other organopolysiloxanes and/or ethoxylated alkylphenols and/or ethoxylated fatty alcohols.

The mixing of components of isocyanate component (A) preferably takes place in a continuous mixing apparatus. Mixing apparatuses that can be used preferably comprise static mixers. Apparatuses of this type are well known to the person skilled in the art. This type of apparatus for the mixing of liquids is described by way of example in EP 0 097 458.

Static mixers are usually tubular apparatuses with fixed internals that serve for the mixing of the individual streams across the cross section of the tube. Static mixers can be used in continuous processes to carry out various operations such as mixing, exchange of substances between two phases, chemical reactions or heat transfer. Homogenization of the starting materials is brought about via a pressure gradient generated by means of a pump. Two fundamental principles of mixing can be distinguished on the basis of the type of flow in the static mixer.

In laminar-flow mixers, homogenization is achieved via partition and transposition of the flow of the individual components. Doubling and redoubling of the number of layers reduces layer thicknesses until complete macro-mixing has been achieved. Micro-mixing via diffusion processes is dependent on the residence time. Laminar-flow mixing is achieved by using helical mixers or mixers with intersecting ducts. Laminar flow is similar to normal tubular flow with low shear forces and narrow residence time distribution.

In turbulent-flow mixers, vortices are intentionally produced in order to homogenize the individual streams of material. Mixers suitable for this purpose are those with intersecting ducts and specific mixers generating turbulence.

Static mixers are commercially available mixing apparatuses, and are supplied by way of example by Fluitec Georg AG, Neftenbach, Switzerland for various application sectors.

The viscosity at 25° C. of resultant isocyanate component (A) is preferably 50 mPas to 700 mPa, particularly preferably from 80 to 500 mPas, more preferably 100 to 300 mPas and in particular 120 to 150 mPas.

The viscosity at 25° C. of isocyanate component A) is preferably below 1000 mPas, preferably below 700 mPas, in particular below 500 mPas, more specifically below 300 mPas, preferably below 250 mPas, particularly preferably below 200 mPas, with particular preference below 150 mPas.

Polyol component (B) preferably comprises no blowing agent (d1); polyol component (B) particularly preferably comprises neither blowing agent (d1) nor blowing agent (d2). If polyol component (B) comprises blowing agent, this is preferably exclusively chemical blowing agents (d3), particularly preferably formic acid and/or water, in particular water.

The viscosity of polyol component (B) at 25° C. is preferably below 1200 mPas, more preferably below 900 mPas, particularly preferably below 700 mPas and in particular below 500 mPas. The viscosity of polyol component (B) at 25° C. is moreover above 100 mPas, more preferably above 200 mPas, particularly preferably above 300 mPas, with further preference above 400 mPas and in particular above 450 mPas.

The person skilled in the art is aware of the methods available here for appropriate adjustment of the viscosity of isocyanate component (A) and of polyol component (B). Said adjustment can by way of example be achieved via selection of lower-viscosity starting materials or addition of known viscosity-reducers, for example surface-active substances.

The ratio by mass of isocyanate component (A) to polyol component (B) is preferably above 1.1, more preferably above 1.2, still more preferably above 1.3, still more preferably above 1.35, still more preferably above 1.4, particularly preferably above 1.45, with particular preference above 1.5, and very particularly preferably above 1.6, and with preference below 2.5, particularly preferably below 2.2 and in particular below 2.0.

Finally, the present invention relates to the use of an isocyanate component (A) comprising polymeric MDI (a) with less than 40% by weight content of difunctional MDI and aliphatic halogenated hydrocarbon compound (d1), and of a polyol component (B) comprising (b1) polyester polyol and (b2) at least one polyether polyol, for the production of polyurethane foams. The present invention also relates to a polyurethane foam obtainable by a process of the invention. The density of these foams of the invention is preferably between 10 and 150 g/L, particularly preferably 15 and 100 g/L, more preferably between 20 and 70 g/L and in particular between 25 and 60 g/L.

The process of the invention provides a number of advantages: components (A) and (B) obtained have good shelf life and permit reliable production of foams. Foams obtained moreover have improved properties, for example improved compressive strength, and also improved dimensional stability.

Examples are used below to explain the invention.

### Process

Parameters were determined as follows:

### Hydroxy Number

Hydroxy number was determined in accordance with DIN 53240 (1971-12).

Envelope Density Envelope density was determined in three different ways:
1) Envelope density by the beaker method
   For this, known volumes of the starting compounds were charged to a beaker and mixed manually therein. After hardening, the foam projecting beyond the edge of the beaker was cut away. Envelope density by the beaker method is the quotient calculated from the weight of foam within the beaker and the volume thereof. Envelope density by the beaker method was determined in accordance with Annex E of European standard EN 14315-1.
2) Core envelope density
   Core envelope density was determined by spraying a plurality of layers of the reaction mixture onto a PE sheet. Core density after hardening of the foam was determined by cutting samples out of the middle of the foam, without skin. These samples were weighed, and their volume was determined, and these values were then used to calculate the density. Core envelope density was determined in accordance with European standard EN ISO 845.
3) Overall free foam density
   Overall free foam density was determined by using the procedure for determination of core envelope density and taking a foam sample from the middle of the sample with all skins from base to surface. These samples were weighed, and their volume was determined, and these values were then used to calculate the density. Overall free foam envelope density was determined in accordance with Annex C of European standard EN 14315-2.

### Cream Time:

Cream time was determined as the time between the start of mixing and the start of volume expansion of the mixture. Cream time was determined in accordance with Annex E of European standard EN 14315-1.

### Gel Time

Gel time was determined as the interval between mixing and the juncture at which threads could be drawn from the reaction mixture. Gel time was determined in accordance with Annex E of European Standard EN 14315-1.

### Tack-Free Time

Tack-free time was determined as the interval between mixing and the juncture at which the upper surface of the foam is no longer tacky. Tack-free time was determined in accordance with Annex E of European standard EN 14315-1.

### Full Rise Time

Full rise time was determined as the interval between start and end of foam expansion. Full rise time was determined in accordance with Annex E of European standard EN 14315-1.

### Thermal Conductivity

The thermal conductivity of a foam sample was determined with use of Lasercomp FOX 314 heat-flux measurement equipment at a temperature of 10° C. in accordance with European standard EN 12667. The samples were produced by spraying a plurality of layers of the reaction mixture onto a PE sheet.

The initial thermal conductivity value was determined in accordance with European standard EN 14315-1-C.3. For this, a specimen measuring 300 mm×300 mm×30 mm was cut out from the core of the foam at most 8 days after production thereof. After conditioning of the sample for 16 hours at 23° C.+−3° C. and 50+−10% relative humidity, the thermal conductivity test was carried out as described above.

### Compressive Strength at 10% Compression

Compressive strength at 10% compression was determined in accordance with European standard EN 826 with use of Instron 5550R test equipment.

### Proportion of Closed Cells

The proportion of closed cells was determined with an ACCUPYC 1330 pycnometer in accordance with European standard EN ISO 4590.

### Dimensional Stability

Dimensional stability was determined in accordance with European standard EN 1604. The specimen was produced by spraying a plurality of layers of the reaction mixture onto a polyethylene sheet. A specimen measuring 200 mm×200 mm×30 mm was cut out from the core. The precise length, width and height of the specimen were determined with a slide gage in each case before and after storage of the specimen for 28 hours at 70° C. and 90% relative humidity. Dimensional stability is given by the difference between the measured values before and after storage.

The following substances were used to produce the examples:
Polyol 1: polyetherol starting from vic-TDA as starter molecule and ethylene oxide and propylene oxide with hydroxy number 390 mg KOH/g
Polyol 2: polyetherol starting from a mixture of sucrose and glycerol as starter molecules and propylene oxide with hydroxy number 450 mg KOH/g
Polyol 3: polyesterol starting from terephthalic acid, diethylene glycol, oleic acid and from a polyetherol, starting from glycerol as starter molecule and ethylene oxide with hydroxy number 240 mg KOH/g
Polyol 4: polyesterol based on phthalic anhydride, diethylene glycol and mono ethylene glycol with hydroxy number 240 mg KOH/g
Polyol 5: polyetherol starting from ethylene diamine as starter molecule and propylene oxide with hydroxy number 470 mg KOH/g
Polyol 6: polyetherol starting from trimethylolpropane as starter molecule and ethylene oxide with hydroxy number 250 mg KOH/g
Polyol 7: polyetherol starting from a mixture of trimethylolpropane as starter molecule and ethylene oxide with hydroxy number 600 mg KOH/g
Polyol 8: polyesterol starting from terephthalic acid, phthalic anhydride, diethylene glycol, oleic acid and glycerol with hydroxy number 240 mg KOH/g
Cat 1: dimethylethanolamine
Cat 2: tris(dimethylaminopropyl)amine, Polycat® 34 from Evonik
Cat 3: pentamethyldiethylenetriamine
Cat 4: dibutyltin dilaurate, Kosmos® 19 from Evonik
Cat 5: mixture of 85% of triethanolamine with 15% of diethanolamine
Cat 6: diethanolamine
Cat 7: Polycat 203 from Evonik
Cat 8: DABCO 2040 from Evonik
Surfactant 1: silicone surfactant, Dabco® DC 193 from Evonik
Surfactant 2: polyetherol starting from nonylphenol and formaldehyde as starter molecules and ethylene oxide with hydroxy number 432 mg KOH/g
Crosslinking agent: glycerol, OH number 1825 mg KOH/g
Flame retardant 1: tris(2-chloroisopropyl) phosphate
Flame retardant 2: triethyl phosphate
Blowing agent 1: trans-1-chloro-3,3,3-trifluoropropene (HCFO-1233zd(E)), Solstice®
   LBA from Honeywell
Blowing agent 2: mixture of 93% by weight of 1,1,1,3,3-pentafluorobutane (HFC-365mfc), Solkane® 365 from Solvay and 7% by weight of 1,1,1,2,3,3,3-heptafluoropro pane (HFC-227ea), Solkane® 227 from Solvay
Blowing agent 3:1,1,1,3,3-pentafluoropropane (HFC-245fa), Enovate® 3000 from Honeywell
Isocyanate 1: Lupranat® M20 S (polymeric methylenediphenyl diisocyanate (PMDI) with viscosity about 210 mPa*s at 25° C. and with 41.8% by weight content of monomeric diphenylmethane diisocyanate from BASF SE
Isocyanate 2: Lupranat® M50 (polymeric methylendiphenyl diisocyanate (PMDI) with viscosity of about 500 mPa*s at 25° C. and with 30.6% by weight content of monomeric diphenylmethane diisocyanate from BASF SE

### Production Process

Polyol components (B) and isocyanate components (A) were produced as in Tables 1 and 2 for Examples 1 to 6.

TABLE 1
Composition of polyol components

| | Example 1 | Example 2 | Example 3 | Example 4 | Example 5 | Example 6 |
|---|---|---|---|---|---|---|
| | (Industry | (Comparative | (of the | (of the | (of the | (of the |
| | standard) | example) | invention) | invention) | invention) | invention) |
| Polyol 3 | | | | | 40.2 | 38.755 |
| Polyol 4 | 29.75 | 33 | 37.5 | 37.5 | | |
| Polyol 5 | 22.63 | 22.63 | 25.8 | 25.105 | | |
| Polyol 1 | | | | | 12 | 11 |
| Polyol 2 | | | | | 6.175 | 6 |
| Polyol 6 | | | | | 12 | 12 |
| Flame retardant 1 | 16 | 16 | 18.1 | 18.1 | 18 | 18 |
| Flame retardant 2 | 3 | 3 | 3.4 | 3.4 | | |
| Cat. 5 | 4 | 3.5 | 3.98 | 4.0 | 2.4 | 3.5 |
| Cat. 6 | 2 | 2 | 2.27 | 2.3 | | |
| Crosslinking | 1.3 | 1.3 | 1.5 | 1.5 | 1.0 | 2.0 |
| agent | | | | | | |
| Surfactant 1 | 0.4 | 0.4 | 0.45 | 0.45 | 1.0 | 1.0 |
| Surfactant 2 | 1.6 | 1.6 | 1.8 | 1.8 | | |
| Cat. 1 | 1 | 1 | 1.15 | 1.3 | 2.1 | 2.0 |
| Cat. 2 | 1.4 | 1.4 | 1.6 | 1.8 | 2.4 | 2.7 |
| Cat. 3 | | | | | 0.28 | 0.3 |
| Cat. 4 | 0.17 | 0.17 | 0.2 | 0.245 | 0.245 | 0.245 |
| Water | 2 | 2 | 2.25 | 2.5 | 2.2 | 2.5 |
| Blowing agent 2 | 9 | | | | | |
| Blowing agent 3 | 5.75 | | | | | |
| Blowing agent 1 | | 12 | | | | |

TABLE 2
Isocyanate components

| | Example 1 | Example 2 | Example 3 | Example 4 | Example 5 | Example 6 |
|---|---|---|---|---|---|---|
| | (Industry | (comparative | (of the | (of the | (of the | (of the |
| | standard) | example) | invention) | invention) | invention) | invention) |
| Isocyanate 1 | 100 | 100 | | | | |
| Isocyanate 2 | | | 90 | 90 | 89 | 90 |
| Blowing agent 1 | | | 10 | 10 | 11 | 10 |

The components are thoroughly mixed and then foamed by the process described below. The polyol component and the isocyanate component were stored at 45° C. in respectively closed containers. After storage, the components were cooled to 20° C. and foamed via intensive mixing of the polyol component with the isocyanate component. The ratio of the volume of the isocyanate component to the volume of the polyol component here was selected in a manner that gave the volumetric mixing ratio reported in Table 3. Table 3 also states the resultant gravimetric ratio by mass of the isocyanate component to the polyol component.

TABLE 3
Volumetric and gravimetric mixing ratio of isocyanate component to polyol component

| | Example 1 | Example 2 | Example 3 | Example 4 | Example 5 | Example 6 |
|---|---|---|---|---|---|---|
| | (Industry | (comparative | (comparative | (of the | (of the | (of the |
| | standard) | example) | example) | invention) | invention) | invention) |
| Volume (isocyanate | 1 | 1 | 1 | 1.25 | 1.25 | 1.5 |
| component)/volume | | | | | | |
| (polyol component) | | | | | | |
| Mass (isocyanate | 1.06 | 1.06 | 1.08 | 1.35 | 1.34 | 1.60 |
| component)/mass | | | | | | |
| (polyol component) | | | | | | |

The following were determined at 45° C. on the resultant samples: cream time, fiber time, full rise time and tack-free time, free-foamed envelope density after various storage times (0 days; 60 days and 120 days). Table 4 collates the result.

TABLE 4
Effect of storage of polyol components and isocyanate components at 45° C. on
foam system reactivity

| | Example 1 | Example 2 | Example 3 | Example 4 | Example 5 | Example 6 |
|---|---|---|---|---|---|---|
| | (Industry | (comparative | (of the | (of the | (of the | (of the |
| | standard) | example) | invention) | invention) | invention) | invention) |
| Storage time | 0 | 0 | 0 | 0 | 0 | 0 |
| [days] | | | | | | |
| Cream time [s] | 2.9 | 2.9 | 3 | 3.1 | 2.8 | 2.8 |
| Fiber time [s] | 7.3 | 7.2 | 7.2 | 7.3 | 6.3 | 6.2 |
| Tack-free time | 8.9 | 9.0 | 9.0 | 8.8 | 8.5 | 8.5 |
| [s] | | | | | | |
| Full rise time | 16.8 | 16.4 | 16.7 | 17 | 13.7 | 13.5 |
| [s] | | | | | | |
| Free-foamed | 33.4 | 33.1 | 33.2 | 33.3 | 32.3 | 32 |
| envelope | | | | | | |
| density [g/l] | | | | | | |
| Storage time | 60 | 60 | 60 | 60 | 60 | 60 |
| [days] | | | | | | |
| Cream time [s] | 3 | 6.7 | 3.2 | 3.4 | 3 | 3 |
| Fiber time [s] | 7.6 | 16.2 | 7.4 | 7.3 | 6.4 | 6.5 |
| Tack-free time | 9.3 | 22.7 | 9.3 | 9.1 | 8.8 | 8.9 |
| [s] | | | | | | |
| Full rise time | 17.3 | 28.3 | 17.3 | 17.5 | 14.2 | 13.8 |
| [s] | | | | | | |
| Free-foamed | 33.2 | 34.4 | 33.2 | 33.2 | 32.8 | 32.5 |
| envelope | | | | | | |
| density [g/l] | | | | | | |
| Storage time | 120 | 120 | 120 | 120 | 120 | 120 |
| [days] | | | | | | |
| Cream time [s] | 3.2 | 10.1 | 4.1 | 4 | 3.5 | 3.3 |
| Fiber time [s] | 8.2 | 30.5 | 8 | 7.9 | 6.8 | 6.9 |
| Tack-free time | 10.0 | 36.8 | 9.8 | 9.6 | 9.2 | 9.3 |
| [s] | | | | | | |
| Full rise time | 18.1 | 49.5 | 17.6 | 17.8 | 14.5 | 14.3 |
| [s] | | | | | | |
| Free-foamed | 32.8 | 35.2 | 33.4 | 33.5 | 33.1 | 32.8 |
| envelope | | | | | | |
| density [g/l] | | | | | | |

It is clear that the reaction times and density of all the foam systems remain almost unchanged during storage at elevated temperature. The only exception is example 2, which after the various storage steps exhibits significantly prolonged reaction times and increased density, and is therefore unsuitable for use in the spray-foam sector. Example 2 was therefore excluded from the machine-foaming below.

The foam systems were moreover studied in a machine-foaming procedure. For this, the mixed polyol components and isocyanate components as stated above were foamed at a component temperature of 42±3° C. in a spray-foam machine, by using a pressure of 100±10 bar to mix the components in a high-pressure mixing head. 5 layers were produced with average layer thickness 2 cm. The test specimens for determining compressive strength, closed-cell factor, thermal conductivity and dimensional stability were taken from the resultant samples. Foam structure was moreover determined by cutting the foam in foam-rise direction and visually assessing foam structure and homogeneity at the cut edge. The results are collated in Table 5.

TABLE 5
Assessment of compressive strength, closed-cell factor,
thermal conductivity, dimensional stability and foam
structure of samples produced by machine-foaming.

| | Industry | Example 3 | Example 4 | Example 5 | Example 6 |
|---|---|---|---|---|---|
| | standard | (of the | (of the | (of the | (of the |
| | example 1 | invention) | invention) | invention) | invention) |
| Core | 37.2 | 37.1 | 38.3 | 38.4 | 38.5 |
| free-foamed | | | | | |
| envelope | | | | | |
| density | | | | | |
| [kg/m³] | | | | | |
| Overall | 38.0 | 37.5 | 39.2 | 39.1 | 39.3 |
| free-foamed | | | | | |
| envelope | | | | | |
| density | | | | | |
| [kg/m³] | | | | | |
| Compressive | 220 | 165 | 220 | 248 | 280 |
| strength | | | | | |
| [kPa] | | | | | |
| Closed-cell | 95 | 81 | 83 | 93 | 93 |
| factor [%] | | | | | |
| Thermal | 20.4 | 23.2 | 22.8 | 21 | 20.8 |
| conductivity | | | | | |
| at 10° C. | | | | | |
| [mW/(m*K)] | | | | | |

Dimensional stability [%] after 48 hours at 70° C. and 90%
relative humidity in the three spatial directions

| | | | | | |
|---|---|---|---|---|---|
| Thickness | 5.2 | 4.3 | 2.3 | 1.9 | 0.3 |
| Width | 4.5 | 5.4 | 3.3 | 1.7 | 0.1 |
| Length | 2.3 | 5.6 | 3.4 | 1.6 | 0.9 |
| Total | 12.0 | 15.3 | 9.0 | 5.2 | 1.3 |

It is clear that the inventive examples 4, 5 and 6 exhibit significantly higher compressive strength than comparative example 3 and indeed in respect of this parameter are in some cases better than the current industry standard based on environmentally friendly HFC blowing agent. The closed-cell factors of the inventive examples are likewise higher, and the thermal conductivities are lower and therefore better than that of comparative example 3. The same is also seen when the dimensional stabilities of the inventive examples are considered in comparison with the comparative example. Indeed, in the inventive examples this parameter is better than in the case of the current industry standard based on HFC as blowing agents.

In contrast to the above, if a conventional spray system is used with isocyanate of relatively high functionality or with a ratio by mass of isocyanate component (A) to polyol component (B) below 1.1, mechanical properties are adversely affected, examples being compressive strength, modulus of elasticity and proportion of closed cells, and the resultant adverse effect on thermal conductivity. This is apparent from the examples below.

The polyol component (B) used here was as follows. This polyol component is hereinafter termed “conventional polyol component”.

TABLE 6
Structure of conventional polyol component

| | |
|---|---|
| Polyol 1 | 12 |
| Polyol 2 | 10 |
| Polyol 7 | 5 |
| Polyol 8 | 35 |
| Crosslinking agent | 0.86 |
| Flame retardant 1 | 16 |
| Cat 3 | 0.2 |
| Cat 4 | 0.24 |
| Cat 7 | 4 |
| Cat 8 | 2 |
| Blowing agent 1 | 12 |
| Water | 1.9 |
| Surfactant 1 | 0.8 |

This was used in the machine example as described above with isocyanate 1 and, respectively isocyanate 2 in various mixing ratios as in table 7:

TABLE 7

| | | Isocyanate | Mixing ratio | |
|---|---|---|---|---|
| | Polyol component | component | Volume | Weight |
| Example 7 | Conventional | Isocyanate 1 | 100:100 | 100:104 |
| (comparative | polyol component | | | |
| example) | | | | |
| Example 8 | Conventional | Isocyanate 1 | 100:125 | 100:130 |
| (comparative | polyol component | | | |
| example) | | | | |
| Example 9 | Conventional | Isocyanate 2 | 100:100 | 100:104 |
| (comparative | polyol component | | | |
| example) | | | | |
| Example 10 | Conventional | Isocyanate 2 | 100:125 | 100:130 |
| (comparative | polyol component | | | |
| example) | | | | |

Test specimens for determination of compressive strength, modulus of elasticity and closed-cell factor were taken from the resultant samples by analogy with Examples 1 and 3 to 6. Foam structure was moreover determined, by cutting the foam in foam-rise direction and, at the cut edge, making a visual assessment of foam structure and homogeneity. Table 8 collates the results.

TABLE 8

| | Example 7 | Example 8 | Example 9 | Example 10 |
|---|---|---|---|---|
| | (comparative | (comparative | (comparative | (comparative |
| | example) | example) | example) | example) |
| Free-foamed | 38.1 | 40.8 | 39.4 | 41.2 |
| envelope | | | | |
| density of | | | | |
| core [kg/m³] | | | | |
| Overall free- | 39.4 | 42.1 | 41.5 | 44.6 |
| foamed density | | | | |
| [kg/m³] | | | | |
| Compressive | 223 | 190 | 175 | 155 |
| strength [kPa] | | | | |
| Closed-cell | 92 | 89 | 85 | 82 |
| factor [%] | | | | |

Table 7 shows that when conventional spray systems are used there is a decrease in compressive strength and in closed-cell factor when isocyanate 2 (with less than 40% content of monomeric isocyanate) is used instead of isocyanate 1 (with more than 40% content of monomeric isocyanate) and, respectively, when the mixing ratio is increased, irrespective of the isocyanate, to more than 1:1.1. Use of isocyanate 2 in Examples 9 and 10 moreover leads to inhomogeneous foams and to heterogeneous cell size.

1. A process for producing a polyurethane foam by mixing the following to give a reaction mixture:
(a) polymeric MDI with less than 40% by weight content of difunctional MDI,
(b) compounds having at least two hydrogen atoms reactive toward isocyanate groups, comprising (b1) at least one polyester polyol and (b2) at least one polyether polyol,
(c) optionally flame retardant,
(d) blowing agent, comprising at least one aliphatic halogenated hydrocarbon compound (d1) composed of 2 to 5 carbon atoms and of at least one hydrogen atom and of at least one fluorine and/or chlorine atom, wherein the compound (d1) comprises at least one carbon-carbon double bond,
(e) optionally catalyst, and
(f) optionally auxiliaries and additional substances,
spraying the reaction mixture onto a substrate, and
allowing said reaction mixture to harden to give the polyurethane foam, wherein
an isocyanate component (A) comprising polyisocyanates (a) and blowing agent (d1), and a polyol component (B) comprising compounds (b) having at least two hydrogen atoms reactive toward isocyanate groups are produced, and then
isocyanate component (A) and polyol component (B), and also optionally other compounds (c), (e) and (f) are mixed to give the reaction mixture, wherein a ratio by mass of the isocyanate component (A) to polyol component (B) is at least 1.2.

2. The process according to claim 1, wherein a viscosity of the polyisocyanates (a) at 25° C. is 250 mPas to 1000 mPas.

3. The process according to claim 1, wherein a proportion of component (d1), based on the total weight of the isocyanate component (A), is 1 to 25% by weight.

4. The process according to claim 1, wherein the isocyanate component (A) further comprises physical blowing agents (d2).

5. The process according to claim 1, wherein the isocyanate component (A) comprises (f1) surface-active substances.

6. The process according to claim 1, wherein a viscosity of the isocyanate component (A) at 25° C. is 50 mPas to 700 mPas.

7. The process according to claim 1, wherein the polyester polyol (b1) comprises at least one polyesterol (b1a) obtainable via esterification of
(b1a1) 10 to 80 mol % of a dicarboxylic acid composition comprising
(b1a11) 20 to 100 mol %, based on the dicarboxylic acid composition, of one or more aromatic dicarboxylic acids or derivatives of same, and
(b1a12) 0 to 80 mol %, based on the dicarboxylic acid composition, of one or more aliphatic dicarboxylic acids or derivatives of same,
(b1a2) 0 to 30 mol % of one or more fatty acids and/or fatty acid derivatives,
(b1a3) 2 to 70 mol % of one or more aliphatic or cycloaliphatic diols having 2 to 18 carbon atoms or alkoxylates of same, and
(b1a4) greater than 0 to 80 mol % of an alkoxylation product of at least one starter molecule with an average functionality of at least two,
based in each case on the total quantity of components (b1a1) to (b1a4), wherein components (b1a1) to (b1a4) give a total of 100 mol %.

8. The process according to claim 7, wherein a number-average molar mass of the polyesterol (b1) is 400 to 1000 g/mol and an average functionality is at least 2.

9. The process according to claim 1, wherein a number-average molar mass of the polyether polyol (b2) is 150 to 3000 g/mol and an average functionality is 2 to 6.

10. The process according to claim 1, wherein the polyester polyol (b1) comprises, alongside the polyester polyol (b1a), a polyester polyol (bib), wherein the polyester polyol (b1b) is produced in an absence of component (b1a4).

11. The process according to claim 1, wherein a ratio by mass of the entirety of components (b1) to component (b2) is 0.1 to 7.

12. The process according to claim 1, wherein the flame retardant comprises at least one compound selected from the group consisting of tris(2-chloropropyl) phosphate (TCPP), diethyl ethanephosphonate (DEEP), triethyl phosphate (TEP), dimethyl propylphosphonate (DMPP), and diphenyl cresyl phosphate (DPC).

13. The process according to claim 1, wherein the blowing agent comprises, alongside component (d1), at least one chemical blowing agent (d3), and the chemical blowing agent (d3) is not a constituent of isocyanate component (A).

14. The process according to claim 1, wherein a viscosity of the polyol component (B) at 25° C. is 100 mPas to 700 mPas.

15. The process according to claim 1, wherein a ratio by mass of the isocyanate component (A) to the polyol component (B) is above 1.2 and below 2.5.

16. A polyurethane foam obtainable by the process according to claim 1.

17. (canceled)
